(19) United States
(12) Patent Application Publication
(10) Pub. No.: US 2010/0170573 A1
(43) Pub. Date: Jul. 8, 2010

(54) PRESSURE RELIEF MECHANISM HAVING A RUPTURE DISK

(76) Inventors: Don R. Draper, Chanhassen, MN (US); David L. Makis, Shakopee, MN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/349,073

(22) Filed: Jan. 6, 2009

(51) Int. Cl. F16K 17/16

(52) U.S. Cl. 137/68.23

(57) ABSTRACT

An exemplary pressure relief mechanism includes a reservoir having an interior cavity for retaining a fluid and a gas. The reservoir includes an aperture that fluidly connects the interior cavity to an exterior region of the reservoir. A rupture disk is arranged across the aperture in the reservoir and substantially blocks the fluid path through the aperture. The rupture disk is configured to open the fluid path through the aperture when a pressure within the interior cavity generally exceeds a predetermined level.

### BACKGROUND

Hydraulic drive systems are known to help facilitate the conversion between mechanical energy (e.g., in the forming of rotating shafts) and hydraulic energy, typically in the form of pressure. One hydraulic drive system that is known for use with respect to vehicles is known by the trademarks Hydraulic Launch Assist™ or HLA® by the assignee of the present application. When a vehicle brakes, mechanical energy from the vehicle motion is captured by the hydraulic drive system and stored in a high pressure storage device. The hydraulic energy can be converted back into mechanical energy by releasing the pressurized fluid stored in the high pressure storage, which in turn can be used to accelerate the vehicle or power other devices.

### BRIEF DESCRIPTION OF THE DRAWINGS

FIG. 1 is a schematic illustration of a vehicle employing an exemplary hydraulic drive/charging system.

FIG. 2 is a side elevational view of an exemplary vehicle employing the drive/charging system.

FIG. 3 is perspective view of the exemplary hydraulic drive/charging system of FIG. 2 shown removed from the vehicle.

FIG. 4 is partial cross-sectional view of a pressure relief mechanism employed with the hydraulic drive/charging system, taken along section line 4-4 of FIG. 3.

FIG. 5 is a partial cross-section view of the pressure relief mechanism of FIG. 4, with a rupture disk shown in a ruptured state.

FIG. 6 is a partial cross-sectional view of a plumbing system for fluidly connecting the pressure relief mechanism to a vehicle container that is fixed relative to the pressure relief mechanism.

FIG. 7 is a partial cross-sectional view of a plumbing system for fluidly connecting the pressure relief mechanism to a vehicle container that is a movable relative to the pressure relief mechanism.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

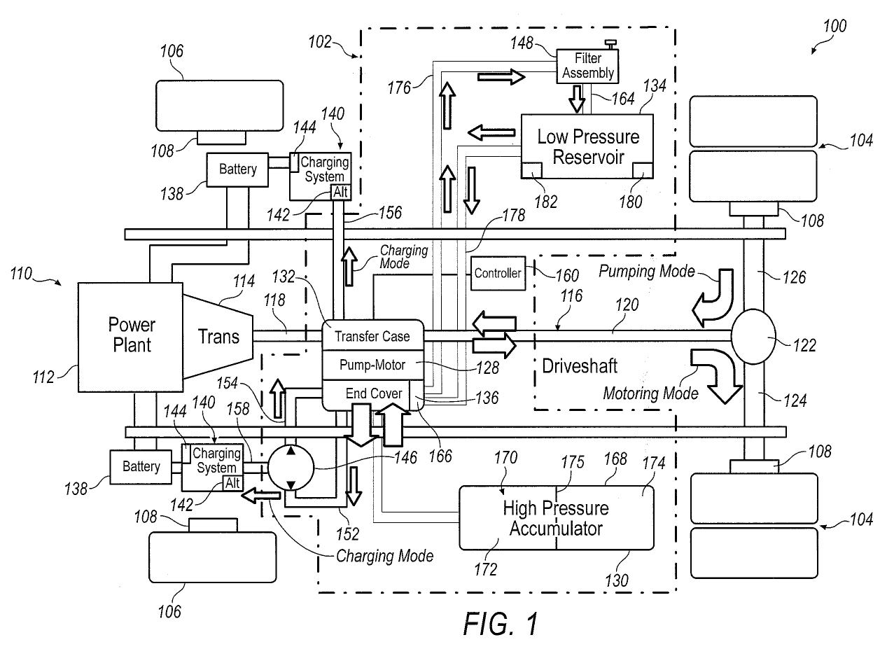

To facilitate the discussion that follows, the leading digits of an introduced element number will generally correspond to the figure number where the element is first introduced. For example, motor vehicle 100 is first introduced in FIG. 1.

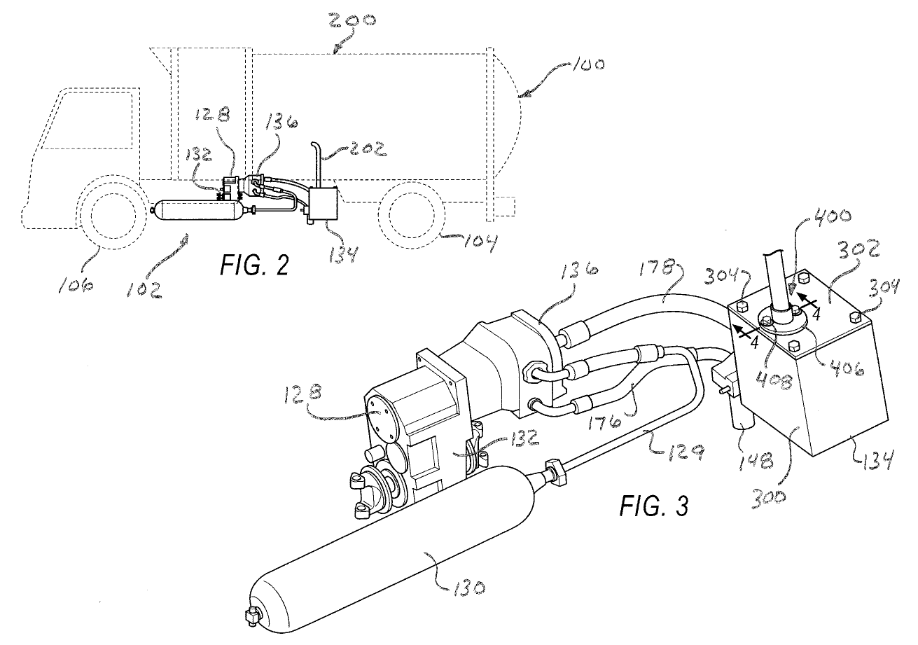

FIG. 1 schematically illustrates a motor vehicle 100 with an exemplary hydraulic drive/charging system 102, known by the trademarks Hydraulic Launch Assist™ or HLA® by the assignee of the present application when used with vehicle 100. An exemplary arrangement within vehicle 100 of some of the various components that make up the hydraulic drive/charging system 102 is shown in FIG. 2. FIG. 3 provides a more detailed depiction of exemplary hydraulic drive/charging system 102, shown removed from vehicle 100 for clarity.

Hydraulic drive/charging system 102 captures energy through pressurized hydraulic fluid and stores a portion of the vehicle's kinetic energy in the form of pressurized gas. The stored hydraulic energy can be converted back into mechanical energy by hydraulic drive/charging system 102, which can be used to propel the vehicle or power other vehicle accessories. For example, the stored hydraulic energy may be used to power a vehicle charging system for at least partially charging a battery that supplies power to an electric motor, such as may be found in an electric or hybrid vehicle. This may in turn enable the vehicle to travel further distances between charges. Such an arrangement is discussed in more detail below.

With reference to FIGS. 1-3, vehicle 100 has four rear drive wheels 104 and two front non-drive wheels 106. In other illustrative embodiments all wheels may be drive wheels. Moreover, there may be more or fewer wheels for vehicle 100. Operably associated with each of the wheels 104 and 106 may be a conventional type of wheel brakes 108. Wheel brakes 108 may be part of an overall electro-hydraulic brake (EHB) or air brake system, of a known type, and commercially available.

Vehicle 100 includes a vehicle drive system, generally designated 110. Vehicle drive system 110 may include a vehicle power plant 112, a transmission 114, and hydraulic drive/charging system 102. Transmission 114 is operatively connected to power plant 112 and transmits torque generated by power plant 112 to rear drive wheels 104. Transmission 114 also interacts with hydraulic drive/charging system 102, as discussed in greater detail below. The particular type of vehicle power plant 112 and transmission 114, and the construction details thereof, as well as the arrangement of vehicle drive system 110, may be varied in a variety of ways. For example, it will be understood that references to a “power plant” include any type of power source or other prime mover, including, but not limited to, an internal combustion engine, electric motor, or combination thereof. Finally, although hydraulic drive/charging system 102 is illustrated and described in connection with a vehicle drive system 110, it may be utilized advantageously with any sort of hydraulic drive/charging system of the type illustrated and described hereinafter, whether or not such system is part of a vehicle.

Extending rearwardly from the transmission 114 and also forming a portion of vehicle drive system 110 is a drive-line, generally designated 116. In the illustrated vehicle drive system 110, and by way of example only, drive-line 116 may include a forward drive shaft 118, a rearward drive shaft 120, an inter-wheel differential 122, and left and right rear axle shafts 124 and 126. Drive-line 116 has been illustrated and described as including shafts 118, 120, 124 and 126 primarily to facilitate understanding of the overall vehicle drive system 110, and not by way of limitation. For example, there may be fewer or more shafts and the shafts may be permanently or selectively connected to one another by way of clutches.

Hydraulic drive/charging system 102 is directed to the storing and releasing of hydraulic energy. As illustrated generally in FIG. 1, hydraulic drive/charging system 102 includes a pump-motor 128 for selectively converting hydraulic energy, stored in the form of high pressure gas in a high pressure accumulator 130, to mechanical energy, as well as converting mechanical energy associated with vehicle drive system 110, and in particular drive-line 116, to hydraulic energy. A transfer case 132 operably connects drive-line 116 to pump-motor 128. Mechanical energy associated with drive-line 116 is transferred through transfer case 132 to pump-motor 128. Pump-motor 128 converts the mechanical energy to hydraulic energy by compressing a low pressure hydraulic fluid delivered to pump-motor 128 from a low pressure reservoir 134. The pressurized hydraulic fluid is transferred from pump-motor 128 through a conduit 129 to high pressure accumulator 130 for storage. The stored energy can be converted back to mechanical energy by passing the high pressure hydraulic fluid through pump-motor 128, which converts the stored energy to mechanical energy that can be output from transfer case 132. The low pressure hydraulic fluid discharged from pump-motor 128 is returned to low pressure reservoir 134 for storage. An end cover 136 may include various valves and controls for controlling the distribution of hydraulic fluid between low pressure reservoir 134, pump-motor 128, and high pressure accumulator 130.

As previously noted, vehicle power plant 112 may include an electric motor for converting electrical energy to mechanical energy for propelling vehicle 100. Power for operating the electric motor can be supplied by one or more batteries 138. Operating the electric motor depletes the energy stored within battery 138, requiring the battery to be occasionally recharged. As illustrated in FIG. 1 vehicle 100 may include a battery charging system 140 for selectively charging battery 138 while operating vehicle 100. Charging system 140 may not be capable of fully charging battery 138 depending on the state of discharge of the battery. Partially charging battery 138, however, may nevertheless increase the amount of time the electric motor may be operated before battery 138 needs to be fully recharged. Battery charging system 140 may include an alternator 142, or other suitable electric current producing source, such as a generator, to produce the desired electric current for charging battery 138. Battery charging system 140 may also include various known electronics 144 for suitably conditioning the electric current for charging battery 138, such as may be required for converting alternating current to direct current. When alternator 142, or another similar device, is used to generate electric current, the mechanical energy required to operate alternator 142 may be supplied from hydraulic drive/charging system 102.

There are various arrangements by which the energy stored within hydraulic drive/charging system 102 can be transferred to alternator 142, two of which are illustrated in FIG. 1. One exemplary arrangement is to suitably couple alternator 142 to an output of transfer case 132, thus enabling mechanical energy produced by pump-motor 128 to be transferred through transfer case 132 to alternator 142. Another exemplary arrangement is to provide a separate hydraulic motor 146 with which to power alternator 142. Hydraulic motor 146 operates in similar manner as pump-motor 128 when operating as a motor. Energy stored in high pressure accumulator 130 is converted to mechanical energy by passing the high pressure hydraulic fluid through hydraulic motor 146, which outputs a rotational torque for operating alternator 142. Low pressure hydraulic fluid discharged from hydraulic motor 146 is returned to low pressure reservoir 134 for storage. For purposes of illustrative convenience, both approaches for transferring energy stored within hydraulic drive/charging system 102 to alternator 142 are illustrated in FIG. 1, and it shall be understood that both approaches do not have to be present in the same system, although they can be. The two exemplary arrangements may be used independent of one another or together in the same system depending on the design and performance requirements of the particular application. It is also to be understood that the two disclosed arrangements are merely to facilitate discussion and are not limiting.

With continued reference to FIG. 1, hydraulic drive/charging system 102 includes transfer case 132, hydrostatic pump-motor 128, end cover 136, hydraulic motor 146, low pressure reservoir 134, a filter assembly 148, and high pressure accumulator 130. Low pressure reservoir 134 is a type of accumulator, but of the low pressure type, as opposed to high pressure accumulator 130. More generally, accumulator 130 is an example of a high pressure storage device while reservoir 134 is an example of a low pressure storage device.

While the various components are illustrated having particular physical structures for convenience of discussion, it is possible for any or all of the components to be within a single or a subset of structures. Merely by way of example, pump-motor 128 and hydraulic motor 146 may be incorporated within end cover 136. Furthermore, pump-motor 128, end cover 136, transfer case 132 and hydraulic motor 146 may be located within a single structure. Moreover, not all components or sub-components (e.g., a specific element) are required. For instance, various components may not be required depending on the approach used for transferring energy stored within hydraulic drive/charging system 102 to alternator 142. As noted previously, FIG. 1 illustrates two separate approaches for transferring energy between hydraulic drive/charging system 102 and alternator 142. One approach entails suitably coupling alternator 142 to transfer case 132, and the other involves providing a separate hydraulic motor 146 to power alternator 142. It should be noted that, for purposes of illustrative convenience, the two alternators 142 associated with the respective approaches are shown in FIG. 1 electrically connected to separate batteries 138. It shall be understood, however, that if both approaches are incorporated into a common system (though they need not be), each alternator may also be electrically connected to a common battery. If power for operating alternator 142 is drawn from transfer case 132, hydraulic motor 146 and its associated flow structure, including conduits 152 and 154, may not be required. Conversely, if power for operating alternator 142 is provided by hydraulic motor 146, certain components within transfer case 132 may not be required, such as certain shafts, clutches and gearing for outputting power to alternator 142.

In general terms, pump-motor 128, hydraulic motor 146, and components within end cover 136 provide the hydraulic pathways for movement of a hydraulic fluid, such as oil, between low pressure reservoir 134 and high pressure accumulator 130. As illustrated in FIG. 1, transfer case 132 may operably connect hydraulic drive/charging system 102 to vehicle drive system 110 and alternator 142. Transfer case 132 may also be mechanically connected to pump-motor 128. Transfer case 132 may include one or more clutches and various gearing to selectively transfer torque between pump-motor 128 and drive shaft 120. Transfer case 132 may also include an alternator shaft 156 operably connecting hydraulic drive/charging system 102 to alternator 142. Transfer case 132 may include an alternator clutch and various gearing to selectively transfer torque between pump motor 128 to alternator 142. It should be noted that the clutch and gearing for connecting pump-motor 128 to alternator 142 may not be required if transfer case 132 is not used to transfer mechanical energy from pump-motor 128 to alternator 142, such as may occur, for example, when using hydraulic motor 146 to power alternator 142.

Pump-motor 128 is used to convert between mechanical energy associated with drive shaft 120, and hydraulic energy stored in the form of pressure within hydraulic drive/charging system 102. Under normal operation of hydraulic drive/charging system 102 in a pumping mode, for example, mechanical energy is stored as hydraulic energy. Conversely, in normal operation of hydraulic drive/charging system 102 in a motoring or battery charge mode, hydraulic energy is converted to mechanical energy.

Typically, vehicle drive system 110, including hydraulic drive/charging system 102, may operate in three different modes at different times. In a first mode of vehicle drive system 110, called a regeneration or pumping mode (typically occurring during a deceleration or braking cycle), a vehicle slows down, such as by an operator signaling a braking operation. Kinetic energy of the vehicle then drives pump-motor 128 as a pump, transferring hydraulic fluid from low pressure reservoir 134 to high pressure accumulator 130, and removing additional torque from drive shaft 120. In the illustrated vehicle drive system 110, energy comes from rear drive wheels 104 in the form of torque, through axle shafts 124 and 126, through differential 122, and then by way of drive shaft 120 to transfer case 132. In some approaches, wheels 106 may include appropriate shafting and related mechanisms to permit a similar recovery of kinetic energy. Energy of braking is transferred from drive shaft 120 through transfer case 132 to pump-motor 128. When a nitrogen gas accumulator is used, the fluid compresses the nitrogen gas within the accumulator 130 and pressurizes hydraulic drive/charging system 102. Under some circumstances, it may be possible to undertake a regeneration or pumping mode using power plant 112 by way of transmission 114 and shaft 118, which may be operably connected to transfer case 132.

In a second mode of vehicle drive system 110, referred to as a launch assist or motoring mode (typically occurring in an acceleration cycle), fluid in high pressure accumulator 130 is metered out to drive pump-motor 128 operating as a motor. Pump-motor 128 applies torque to drive shaft 120, and then through differential 122, axle shafts 124 and 126, and finally to wheels 104. The motoring mode stops when a selected portion of the available pressure is released from high pressure accumulator 130. Before motoring can again commence, regeneration of high pressure accumulator 130 using the pumping mode will need to occur.

In a third mode of vehicle drive system 110, called a battery charge mode, which typically occurs when the vehicle is not operating in a braking cycle (although it may occur during a braking cycle when high pressure accumulator 130 is generally fully pressurized), fluid in the high pressure accumulator 130 is metered out either to pump-motor 128 or hydraulic motor 146, depending on whether transfer case 132 or hydraulic motor 146 is used to power alternator 142, at a flow rate dictated by the charge rate of battery 138. When using transfer case 132 to power alternator 142, torque generated by pump-motor 128 is transferred through transfer case 132 to alternator shaft 156, and then to alternator 142. Alternator 142 generates an electric current for at least partially charging battery 138. When using hydraulic motor 146 to power alternator 142, torque produced by hydraulic motor 146 is transferred through a shaft 158 to alternator 142. The battery charge mode stops when a selected portion of the pressure is released from high pressure accumulator 130. At least partial regeneration of high pressure accumulator 130 using the pumping mode needs to occur before battery charging can again commence.

A controller 160 at least partly controls hydraulic drive/charging system 102. Various informational inputs are received by controller 160, and then heuristics, i.e., logical rules or processes, are applied to the inputs. Outputs are then generated that influence operation of hydraulic drive/charging system 102 in the context of the overall operation of drive system 110 and battery charging system 140 of vehicle 100. While a separate controller 160 is illustrated, controller 160 may be incorporated into an overall vehicle electronic control unit (ECU) or as part of an ECU associated with engine 112 or transmission 114, or some combination thereof.

Continuing to refer to FIG. 1, drive/charging system 102 may include a filter assembly 148. It is envisioned that various filter assemblies 148 may be used within hydraulic drive/charging system 102. One exemplary filter assembly 148 is discussed in co-pending application Ser. No. 11/408,504, which is a continuation-in-part of application Ser. No. 10/828,590 and a continuation-in-part of Ser. No. 10/624,805, all of which are incorporated herein in their entirety. Filter assembly 148 is in communication with a port of low pressure reservoir 134 by means of a conduit 164, disposed on the “low pressure” side of hydraulic drive/charging system 102. The operation of an exemplary filter assembly 148 in the context of a hydraulic drive system, such as exemplary hydraulic drive/charging system 102, is discussed in greater detail in U.S. Pat. No. 6,971,232, the contents of which are incorporated herein by reference in their entirety.

In one illustration, pump-motor 128 is of the variable displacement type. However, pump-motor 128 may be of many types of construction, including but not limited to, bent axis, vane, or radial piston.

End cover 136 may include a mode control valve assembly 166 for selectively controlling the flow of fluid between low pressure reservoir 134 and high pressure accumulator 130 when operating in the pumping or drive mode, as well as when operating in the battery charge mode where transfer case 132 provides the torque for driving alternator 142. The operation of an exemplary mode control valve assembly 166 in the context of a hydraulic drive system, such as exemplary hydraulic drive/charging system 102, is discussed in greater detail in U.S. Pat. No. 6,971,232, the contents of which are incorporated herein by reference in their entirety.

High pressure accumulator 130 is illustrated as being located outside of end cover 136. However, as noted above, in some cases components, such as high pressure accumulator 132, can be located in the same physical housing or structure as those discussed with respect to end cover 136. Similarly, components physically located within end cover 136, for example, may be associated with other structures without precluding proper operation of hydraulic drive/charging system 102.

High pressure accumulator 130 represents the termination of the “high pressure” side of hydraulic drive/charging system 102. By way of example only, high pressure accumulator 130 may be of the gas-charge type. A gas-charge accumulator typically includes a rigid outer shell 168 defining an internal chamber 170. Internal chamber 170 is typically divided into a liquid chamber 172 and a gas chamber 174. There exist various alternatives for separating the two chambers, including but no limited to, an elastic diaphragm, an elastic bladder, or a floating piston. The various alternatives are represented generically by a single line 175 bisecting high pressure accumulator 130. Liquid chamber 172 receives pressurized hydraulic fluid from pump-motor 128 when operating the hydraulic drive/charging system 102 in the pumping mode. Gas chamber 174 generally contains a compressible gas, such as nitrogen for example. The pressurized hydraulic fluid received from pump-motor 128 compresses the volume of gas in accumulator 130. The compressed gas provides the compressive force necessary for discharging the hydraulic fluid from accumulator 130 when operating the hydraulic drive/charging system 102 in the motoring or battery charging mode. At the end of a typical deceleration cycle (pumping mode), high pressure accumulator 130 is may be charged up to the maximum system pressure, typically about 5000 pounds per square inch (PSI), but possibly even higher.

Low pressure reservoir 134 represents the termination of the “low pressure” side of hydraulic drive/charging system 102. A conduit 176 provides hydraulic fluid to low pressure reservoir 134 by way of filter assembly 148, while conduit 178 represents the pathway by which fluid is removed from the reservoir, such as when charging high pressure accumulator 130.

Reservoir 134 may include a hydraulic fluid level sensor 180 and a hydraulic fluid temperature sensor 182. The sensors may be analog, digital, or of any type performing the requested function. The level of fluid within low pressure reservoir 134 increases as motoring and battery charging takes place, and decreases as pumping removes fluid from the reservoir to recharge high pressure accumulator 130. The fluid level is also increased when hydraulic drive/charging system 102 is shut down. Typically, the temperature of the hydraulic fluid will increase as hydraulic drive/charging system 102 is utilized, but is also influenced by outside environmental conditions, such as ambient temperature.

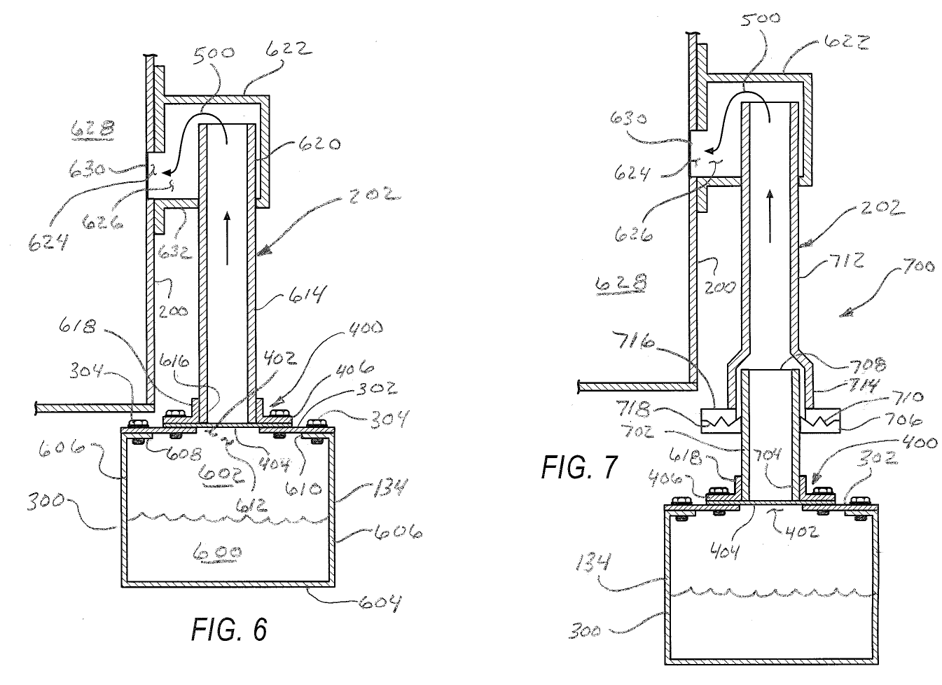

Referring to FIGS. 2 and 3, an exemplary low pressure reservoir 134 may include a reservoir tank 300 for capturing and storing a hydraulic fluid 600 (see FIG. 6) employed in hydraulic drive/charging system 102. To prevent dirt and other containments from collecting in reservoir tank 300, as well as preventing hydraulic fluid from spilling from the tank, reservoir 134 may include a cover 302 attached to an upper end of reservoir tank 300. Hydraulic fluid may be withdrawn from reservoir tank 300 when operating hydraulic drive/charging system 102 in the pumping mode, and may be returned to the tank when operating the hydraulic drive/charging system in the motoring mode.

Reservoir 134 may have any of a variety of different geometric configurations depending, at least in part, on the requirements of the particular application. In the exemplary configuration shown in FIGS. 2 and 3, reservoir 134 is shown to have a generally rectangular shape. It shall be appreciated, however, that in practice, other geometric configurations may also be employed. For example, placement and packaging requirements of reservoir 134 within a vehicle may dictate that reservoir 134 be multi-facetted and/or include various contoured surfaces to enable the tank to be installed within the allocated confines of the vehicle. Various geometric configurations that may be employed, include, but are not limited to, spherical, cylindrical, rectangular, and polygonal, among others, or any combination thereof. It shall be understood that the illustrated tank configuration merely represents one of a multitude of different geometric configurations that may be utilized. The geometric configuration depicted in the drawing figures was selected for illustrative convenience only, and thus, is not intended to be limiting in any way.

With reference also to FIGS. 6 and 7, exemplary reservoir tank 300 includes an interior cavity 602 defined by a bottom panel 604 and one or more sidewalls 606. Contained within interior cavity 602 is hydraulic fluid 600. Arranged near the top of sidewalls 606 is a flange 608 that extends inward from each of the sidewalls at an angle generally perpendicular to the walls. Flange 608 provides a generally continuous ledge extending around the entire inner perimeter of sidewalls 606. An inner edge 610 of the flange defines an opening 612 that permits access to interior cavity 602 of reservoir tank 300.

Cover 302 may be configured to completely cover opening 612 when the cover is attached to reservoir tank 300. Cover 302 may be attached to reservoir tank 300 using one or more fasteners 304. For purposes of discussion, fasteners 304 are illustrated in the exemplary configuration as threaded bolts; however, it shall be appreciated that other attachment devices may also be employed, such as screws and rivets. Fasteners 304 threadably engage a correspondingly threaded aperture in flange 608. Fasteners 304 may alternatively engage a correspondingly threaded nut fixedly attached to a bottom surface of flange 608, which may eliminate the need to thread the apertures in flange 608 in order to threadably receive fasteners 304. A gasket may be arranged between cover 302 and flange 608 to minimize leakage through the joint interface.

Reservoir tank 300 and cover 302 may be constructed from any of a variety of materials, including but not limited to, metals, such as, steel (including stainless steel) and aluminum, plastics, fiberglass, and composite materials, among others. Reservoir tank 300 and cover 302 may be constructed from the same material or from different materials.

Reservoir 134 typically operates at a low internal pressure, which may range from atmospheric to slightly higher than atmospheric. For example, the internal operating pressure may fall in the range of zero bar (0 psi) to 0.14 bar (2 psi). Certain operating conditions or events, however, may cause the internal pressure to exceed the reservoir's generally expected maximum internal operating pressure. For example, a rupture occurring in flexible membrane 175 of high pressure accumulator 130 may allow the high pressure gas in chamber 174 to be transported to reservoir 134 when hydraulic drive/charging system 102 is operated in the motoring/charging mode. The high pressure gas may cause the internal pressure within reservoir 134 to rise beyond what would be expected under normal operating conditions. As discussed previously, flexible membrane 175 provides a barrier separating the high pressure gas present in chamber 174 from the hydraulic fluid present in chamber 172. A rupture occurring in membrane 175 may allow the high pressure gas and the hydraulic fluid to mix together. Operating hydraulic drive/charging system 102 in the motoring/charging mode will allow the gas/fluid mixture to pass through pump-motor 128 (operating as a motor) and into reservoir 134. Pump-motor 128 is generally more efficient at extracting stored pressure energy from a fluid than a gas. As a consequence, a substantial portion of the pressure energy stored in the gas may not be converted to mechanical energy as the gas/fluid mixture passes through pump-motor 128, but instead will continue to be stored in the gas as pressure. The gas/fluid mixture discharged from pump-motor 128 will thus arrive at reservoir 134 at a higher energy and pressure than if only hydraulic fluid had passed through the pump-motor. The higher pressure of the gas/fluid mixture may cause the internal pressure in reservoir 134 to exceed the generally expected operating range.

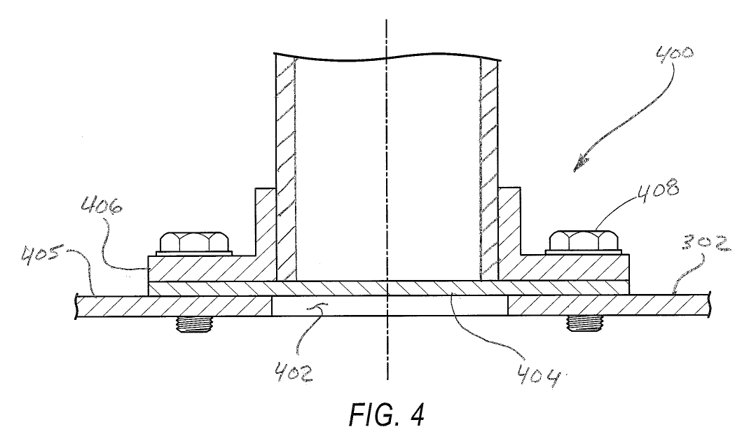

With reference to FIGS. 4-6, to accommodate the potential higher internal pressure that may occur within reservoir 134, a pressure relief mechanism 400 may be employed for allowing excess pressure to escape from the reservoir when the internal pressure exceeds a predetermined level. Pressure relief mechanism 400 may include an orifice 402 formed in either cover 302 or one of the sidewalls 606 of reservoir 134. Although shown as formed in cover 302, it shall be appreciated that orifice 402 may also be incorporated in any of the sidewalls 606. Orifice 402 provides a fluid pathway between interior cavity 602 of reservoir 134 and an exterior region of the reservoir. Orifice 402 may have any of a variety of geometric shapes, including but not limited to, circular, square, and polygonal, among others. For purposes of discussion, the orifice in the exemplary configuration is circular shaped.

The fluid pathway through orifice 402 may be blocked by a rupture disk 404 positioned across the orifice. Rupture disk 404 completely covers orifice 402 to substantially prevent pressurized gas and fluid from escaping through the orifice. Rupture disk 404 engages an outer surface 405 of cover 302 and may be secured in place by a mounting ring 406 positioned around an outer perimeter of orifice 402. Mounting ring 406 may be attached to cover 302 using one or more threaded fasteners 408, such as bolts, that threadably engage a correspondingly threaded aperture in cover 302. Mounting ring 406 may also be attached to cover 302 using a variety of other attachment mechanisms, including but not limited to, screws and rivets. With mounting ring 406 secured to cover 302, rupture disk 404 is trapped between mounting ring 406 and cover 302.

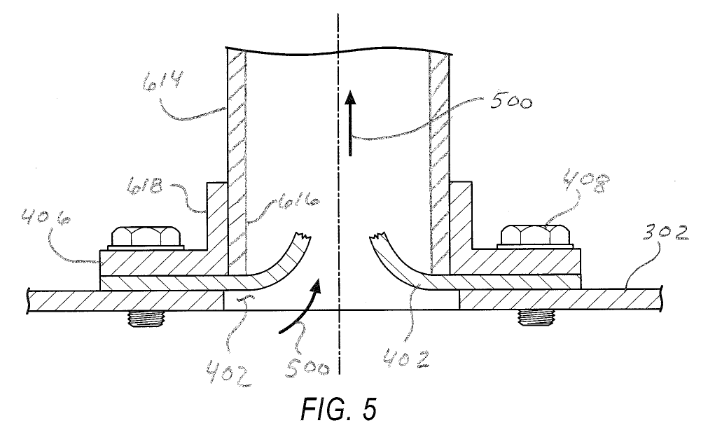

Rupture disk 404 is configured to rupture and allow excess pressure to escape from reservoir 134 (see FIG. 5) when the pressure within interior cavity 602 exceeds a predetermined limit. Rupture disk 404 may be constructed from a variety of materials, including but not limited to, rubber, such as buna-n, metal, such as aluminum or stainless steel, and other frangible materials, such as glass and certain plastics, among others. The material selected should have reasonable fatigue resistance and its material properties should not be adversely affected by the fluids employed in the hydraulic system and the environment in which it operates. The surface area of rupture disk 404 exposed to orifice 402 and the material composition and thickness of rupture disk 404 determine, at least in part, the pressure at which the rupture disk ruptures. For example, the thicker the rupture disk the higher the internal cavity pressure required to cause the disk to rupture. When the internal pressure within internal cavity 602 exceeds the predetermined pressure limit, rupture disk 404 will rupture and allow pressurized gas 500, and possibly hydraulic fluid, to escape from reservoir 134. Discharging pressurized gas from reservoir 134 produces a corresponding drop in internal pressure within reservoir 134.

The ruptured rupture disk 404 (see FIG. 5) may be readily replaced by disconnecting threaded fasteners 408 from cover 302 and mounting ring 406. This allows mounting ring 406 to be disengaged from rupture disk 404, which in turn can be separated from cover 302. A new rupture disk may then be positioned relative to orifice 402 and secured in place with mounting ring 406 and threaded fasteners 408.

When the pressure within interior cavity 602 of reservoir 134 reaches a pressure sufficient to cause rupture disk 404 to rupture, pressurized gas, and possibly hydraulic fluid, may be discharged from orifice 402. The gas/fluid mixture may discharge to atmosphere, or may be directed through a system of conduits to a separate container on the vehicle where the discharged gas/fluid mixture may be collected and retained for later disposal. For example, representative vehicle 100, as shown in FIG. 2, may include a container 200 used for collecting and transporting various waste materials. Container 200 may provide a suitable container for capturing the gas/fluid mixture discharged through orifice 402. A conduit system 202 may be provided for directing the discharged gas and fluid to container 200. In this exemplary configuration, container 200 primarily functions as a container for transporting refuse, but may also provide a suitable container for retaining the gas and fluid discharged through orifice 402. Other vehicles, such as delivery trucks, may not include a container suitable for capturing and retaining the discharged gas and fluid. For those vehicles, a separate container configured to receive the discharged gas and fluid may be provided on the vehicle.

With particular reference to FIG. 6, conduit system 202 may include a conduit 614 having one end 616 fluidly connected to orifice 402. Conduit 614 may be held in position by engaging end 616 with a correspondingly shaped flange 618 extending from mounting ring 406. Conduit 614 may be secured to flange 618 by a variety of means, including but not limited to, welding, brazing, soldering, and gluing. An opposite end 620 of conduit 614 may engage a plenum 622 attached to a wall of container 200. Plenum 622 may be arranged over an opening 624 extending through a sidewall of container 200. Opening 624 provides a fluid path between an interior cavity 626 of plenum 622 and an interior cavity 628 of container 200. A screen 630 may be secured over opening 624 help prevent debris in container 200 from collecting in plenum 622.

Conduit 614 may be either fixedly or slidably connected to plenum 622. In the exemplary configuration illustrated in FIG. 6, conduit 614 extends through an aperture in a bottom wall 632 of plenum 622. The connection interface between conduit 614 and plenum 622 may be configured as a slip type interface to accommodate movement that may occur between the plenum and the conduit, for example, when operating vehicle 100. The connection interface between conduit 614 and plenum 622 may include a seal to minimize potential leakage through the joint interface. End 620 of conduit 614 may also be fixedly attached to plenum 622, such as by welding, brazing, soldering, gluing, as well as other attachment mechanisms, particularly in instances where there is little or no relative movement between reservoir 134 and plenum 622.

In the event rupture disk 404 ruptures due to the pressure within reservoir 134 exceeding a certain level, the pressurized gas, and possibly hydraulic fluid, discharged from orifice 402 will travel through conduit 614 to plenum 622. From there, the discharged mixture will pass through opening 624 in the side wall of container 200 to be discharged into interior cavity 628 of container 200.

The exemplary conduit system illustrated in FIG. 6 may be employed in instances where the physical arrangement between container 200 and reservoir 134 generally does not change. Although the connection interface between conduit 614 and plenum 622 may be configured to accommodate a certain amount of movement between the two components, such a configuration may not be suitable for handling large displacements. For example, container 200 of vehicle 100 may be configured to pivot relative to a frame of the vehicle to enable the refuse material to be dumped from the container. If reservoir 134 is not mounted to container 200, but rather is generally fixed relative to the vehicle frame, a substantial amount of movement may occur between container 200 and reservoir 134 as the container is pivoted. To accommodate the possibly large relative displacement between container 200 and reservoir 134, conduit system 202 may be configured to include a detachable connection interface 700 for fluidly disconnecting container 200 from reservoir 134 when container 200 is pivoted.

With reference to FIG. 7, detachable connection interface 700 may include a first conduit 702 fluidly connected to orifice 402. An end 704 of first conduit 702 may engage flange 618 of mounting ring 406 in a similar manner as previously describe with respect to conduit 614 (see FIG. 6). Attached to an outer circumference of first conduit 702 is a first seal flange 706 extending generally radially outward from the first conduit. First seal flange 706 may be disposed inboard of a distal end 708 of first conduit 702. A side of first seal flange 706 opposite reservoir 134 includes a first sealing surface 710.

A second conduit 712 may be fixedly attached to plenum 622 in a similar manner as previously described with respect to conduit 614 (see FIG. 6). Second conduit 712 may include a flared end 714 opposite plenum 622. Flared end 714 may be sized to receive end 708 of first conduit 702 when the two conduits are coupled together.

Attached to an outer circumference of second conduit 712 is a second seal flange 716 extending generally radially outward from the second conduit. Arranged on a side of second seal flange 716 opposite plenum 622 is a second sealing surface 718. Second sealing surface 718 engages first sealing surface 710 of first seal flange 706 when the first and second conduits are coupled together to substantially prevent pressurized gas and fluid from escaping through the connection interface.

Pivoting container 200 of vehicle 100 away from reservoir 134 will cause first conduit 702 to separate from second conduit 712. Reversing the process, by pivoting container 200 back toward reservoir 134, will cause end 708 of first conduit 702 to engage flared end 714 of second conduit 712. With container 200 returned to its non-pivoted position, second sealing surface 718 of second conduit 712 will sealingly engage first sealing surface 710 of first conduit 702.

With first conduit 702 engaging second conduit 712, the exemplary pressure relief mechanism illustrated in FIG. 7 operates in a similar manner as previously describe with respect to the pressure relief mechanism illustrated in FIG. 6. In the event rupture disk 404 ruptures due to the pressure within reservoir 134 exceeding a certain maximum pressure level, the pressurized gas, and possibly hydraulic fluid, discharged from orifice 402 will travel through first conduit 702 to second conduit 712. The fluid/gas mixture is discharged from second conduit 712 into plenum 622. From there, the fluid/gas mixture passes through opening 624 in the sidewall of container 200 and into interior cavity 628 of container 200.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A pressure relief mechanism comprising:
a reservoir having an interior cavity for retaining at least one of a fluid and a gas, the reservoir including an aperture for fluidly connecting the interior cavity to an exterior region of the reservoir;
a rupture disk arranged across the aperture in the reservoir, the rupture disk substantially blocking the fluid path through the aperture, the rupture disk configured to open the fluid path through the aperture when a pressure within the interior cavity generally exceeds a predetermined level.

2. The pressure relief mechanism of claim 1 further comprising a mounting ring attached to the reservoir and engaging the rupture disk.

3. The pressure relief mechanism of claim 2, wherein the rupture disk is trapped between the reservoir and the mounting ring.

4. The pressure relief mechanism of claim 2 further comprising a conduit for fluidly connecting the aperture to a container separate from the reservoir.

5. The pressure relief mechanism of claim 4, wherein the conduit is fixedly attached to the mounting ring.

6. The pressure relief mechanism of claim 4 further comprising a plenum fluidly connected to the conduit, the plenum fluidly connectable to the separate container.

7. The pressure relief mechanism of claim 4 further comprising a second conduit fluidly connectable to the first conduit.

8. The pressure relief mechanism of claim 7 further comprising a seal having a first sealing surface connected to the first conduit and a second sealing surface connected to the second conduit, the first sealing surface engaging the second sealing surface when the first conduit is fluidly engaged with the second conduit.

9. The pressure relief mechanism of claim 7 further comprising a plenum fluidly connected to the second conduit, the plenum fluidly connectable to the container.

10. The pressure relief mechanism of claim 9, wherein the second conduit slidably engages the plenum.

11. The pressure relief mechanism of claim 1, wherein one side of the rupture disk is in fluid communication with the interior cavity of the reservoir, and an opposite side of the rupture disk is in fluid communication with the exterior region of the reservoir.

12. The pressure relief mechanism of claim 1, wherein the rupture disk includes a frangible material.

13. A pressure relief mechanism comprising:
a reservoir having an interior cavity for retaining at least one of a fluid and a gas;
a container separate from the reservoir for receiving at least one of the fluid and the gas from the reservoir;
a conduit defining a fluid path between the reservoir and the container; and
a rupture disk disposed within the fluid path between the reservoir and the container, the rupture disk substantially blocking the fluid path between the reservoir and the container and configured to open the fluid path when a pressure within the interior cavity exceeds a predetermined level

14. The pressure relief mechanism of claim 13, wherein the container is moveable between a first position and a second position relative to the reservoir, the conduit further comprising a seal having a first sealing surface and a second sealing surface, the first and second sealing surfaces being engaged when the container is in the first position and disengaged when the container is in the second position.

15. The pressure relief mechanism of claim 14, further comprising a first conduit fluidly connected to the reservoir and a second conduit fluidly connected to the container, the first conduit fluidly engaging the second conduit when the container is in the first position, and the first conduit being fluidly disengaged from the second conduit when the container is in the second position.

16. The pressure relief mechanism of claim 15, wherein at least a portion of one of the first and second conduits is disposed within the other conduit when the container is in the first position.

17. The pressure relief mechanism of claim 15 further comprising a plenum fluidly connected to the container and the second conduit.

18. The pressure relief mechanism of claim 17, wherein the second conduit is fixedly attached to the plenum.

19. The pressure relief mechanism of claim 13, wherein the rupture disk is disposed adjacent an aperture in the reservoir.

20. The pressure relief mechanism of claim 13, wherein the rupture disk includes a frangible material.
